(19) United States
(12) Patent Application Publication
(10) Pub. No.: US 2014/0180974 A1
(43) Pub. Date: Jun. 26, 2014

(54) Transaction Risk Detection

(71) Applicant: FAIR ISAAC CORPORATION, Minneapolis, MN (US)

(72) Inventors: Matthew Bochner Kennel, Roseville, MN (US); Hua Li, San Diego, CA (US); Larry Peranich, San Diego, CA (US)

(73) Assignee: FAIR ISAAC CORPORATION, Minneapolis, MN (US)

(21) Appl. No.: 13/725,561

(22) Filed: Dec. 21, 2012

(51) Int. Cl. G06N 99/00

(52) U.S. Cl. CPC G06N 99/005
USPC 706/12

(57) ABSTRACT

The current subject matter describes scoring of transactions associated with a profiling entity so as to determine risk associated with the transactions. Data characterizing at least one new transaction can be received. A latent dirichlet allocation (LDA) model trained on historical data can be obtained. Based on new words in the received data, the LDA model can update a topic probability mixture vector. Based on the updated topic probability mixture vector, numerical values of one or more predictive features can be calculated. Based on the numerical values of the one or more predicted features, the at least one transaction in the received data can be scored. Related apparatus, systems, techniques and articles are also described.

### TECHNICAL FIELD

The subject matter described herein relates to scoring of transactions associated with an entity so as to determine risk associated with the transactions.

### BACKGROUND

Conventional systems can detect risk associated with transactions of a customer. Typically, financial institutions mark (for example, red-flag) the customer at risk, and block the further transactions for such a customer. However, such detection of risk can often be inaccurate, and the blocking of further transactions can cause a loss of business for the financial institutions. Further, inaccurate risk detection can cause some customers to become disloyal. Moreover, such a detection of risk can require a significant amount of time, as all calculations associated with detection of risk are typically re-performed, thereby not informing about the risk in desired time, thereby causing a further loss for the financial institutions. Furthermore, such a conventional detection of risk can typically require significant and excessive computing resources, such at least the memory and computing processor resources.

### SUMMARY

The current subject matter describes scoring of transactions associated with an entity so as to determine risk associated with the transactions. The entity can be one of: a customer, a merchant, a bank account, a sales channel (for example, an internet sales channel), a product, and other entities.

In optional variations, one or more of the following additional features can be included in any feasible combination. The at least one transaction can be between a first set of one or more merchants and a first set of one or more customers and the historical transactions can be between a second set of one or more merchants and a second set of one or more customers. The first set of one or more merchants can be different from the second set of one or more customers, and the first set of one or more merchants can be different from the second set of one or more customers. The topic model can include a latent Dirichlet allocation (LDA) model.

The updating of the topic probability mixture vector can include initializing a first vector characterizing a multiple of the topic probability mixture vector; applying an optional time delay to the first vector to modify the first vector; computing, based on the modified first vector, an initial estimate of the topic probability mixture vector; computing, based on the initial estimate of the topic probability mixture vector, a second vector; enhancing the second vector by using a temporary vector; updating, based on the enhanced second vector and an upper bound characterizing a time window for collecting the historical data, the modified first vector; and computing, based on the updated first vector, a final value of the topic probability mixture vector, the final value of the topic probability mixture vector being the updated topic probability mixture vector. The time delay is characterized by: exp(−Δ/T), wherein: exp is an exponential function, Δ is a time difference between an old transaction and a new transaction, and T is a time constant. The initial estimate of the topic probability mixture vector can be characterized by:

$${θ}_{k} = \frac{{ζ}_{k}}{{\sum }_{k = 1}^{K} {ζ}_{k}} ,$$

wherein: θₖ is k^{th} value in the topic probability mixture vector θ, ζ is the modified first vector, and ζₖ is k^{th} value in the modified first vector ζ. The second vector γ can be characterized by: γ_{n,k}=p(tₖ|wₙ,θ), wherein:

$$p ( {t}_{k} \vert {w}_{n} , θ ) = \frac{p ( {w}_{n} \vert {t}_{k} , θ ) p ( {t}_{k} \vert θ )}{p ( {w}_{n} \vert θ )} = \frac{{φ}_{m , k} {θ}_{k}}{p ( {w}_{n} \vert θ )} ,$$

m is an index of a current word in the topic matrix φ, and θₖ is k^{th} element of the topic probability mixture vector θ, wherein

$$p ( {w}_{n} \vert θ ) = {\sum }_{k = 1}^{K} {φ}_{m , k} {θ}_{k} .$$

The temporary vector τ can be characterized by:

$${τ}_{k} = {ζ}_{k} + {\sum }_{n = 1}^{N} {γ}_{n , k} ,$$

wherein ζₖ is k^{th} value in the modified first vector ζ, and γ is the second vector.

The one or more predictive features can include a predictive code length feature characterized by:

$${L}_{w} = - log \hat{p} ( w \vert θ ) = - log ( {\sum }_{k} {φ}_{m , k} {θ}_{k} )$$

wherein L_{w} is a predictive code length of a new word w associated with the received data characterizing the at least one transaction; \hat{p}(w|θ) is a conditional probability associated with new word w and topic vector θ; and Φ_{m,k} is a probability of a word m being associated with a topic k. The predictive code length can characterize a minimum code length required to compress the new word in a sequentially updating lossless compression. Common words can have a low value of the predictive code length, and uncommon words can have a high value of the predictive code length.

The one or more predictive features can include a relative predictive code length feature characterized by:

\tilde{L}_{w}=−log \hat{p}(w|θ)−log \hat{p}(w)

wherein:

$$- log \hat{p} ( w \vert θ ) = - log ( {\sum }_{k} {φ}_{m , k} {θ}_{k} ) ;$$

L_{w} is a relative predictive code length of a new word w; \hat{p}(w|θ) is a conditional probability associated with new word w and topic vector θ; Φ_{m,k} is a probability of a word m being associated with a topic k; and \hat{p}(w) is a baseline probability of the new word determined regardless of the historical data.

The one or more predictive features can be provided as input to one or more predictive models that generate the score. The one or more predictive models can include at least one of: linear regression models, nonlinear regression models, artificial neural network models, decision trees, support vector machines, and scorecard models.

In another interrelated aspect, a method includes receiving historical data comprising data associated with transactions between a first set of one or more transacting partners and a first set of one or more transacting entities, and generating, from the historical data, characteristics characterizing words. The method further includes obtaining a numerical value of a number of topics desired to be determined, determining the numerical value number of topics that are associated with the one or more transacting entities, associating the topics with the words in a topic model, and generating a topic probability mixture vector by using the topic model. The topic vector is updated in run-time to characterize risk associated with subsequent transactions in the run-time.

In optional variations, one or more of the following additional features can be included in any feasible combination. The historical data can be selected for a variable time period, the historical data can be received at a characteristics generator, and the characteristics can be generated by the characteristics generator. The words can characterize categorical data in the historical data, and the topics can characterize patterns determined from the historical data. The topic model can characterize a topic-word matrix that provides a measure of association between words and topics. Each value in the topic-word matrix can characterize a probability of association of a specific word with a corresponding topic, and the topic probability mixture vector can include probabilities. Each probability can characterize a likelihood of association of a particular word with a respective topic.

The method can further include receiving a new data characterizing one or more transactions between a second set of one or more new transacting partners and a second set of one or more new transacting entities; updating the topic probability mixture vector when the new data is received; calculating, based on at least one of the topic probability mixture vector prior to the update and the updated topic probability mixture vector, values of one or more predictive features; scoring, based on the calculated values of the one or more predicted features, a transaction in the new data to generate a score; and initiating a provision of the score. The first set of one or more transacting partners can be different from the second set of one or more new transacting partners, and the first set of one or more transacting entities can be different from the second set of one or more new transacting entities. The method can also or alternatively further include extracting, from the new data, new words to be input to the topic model and generating, by the topic model, the updated topic probability mixture vector.

The updating of the topic vector can include updating a multiple associated with the topic vector, the multiple being stored and associated with a profiled transacting entity until another new transaction is received while the topic vector is discarded. The one or more predictive features comprise a predictive code length feature characterized by:

$${L}_{w} = - log \hat{p} ( w \vert θ ) = - log ( {\sum }_{k} {φ}_{m , k} {θ}_{k} )$$

wherein: L_{w} is a predictive code length of a new word w; \hat{p}(w|θ) is a conditional probability associated with new word w and topic vector θ; and Φm,k is a probability of a word m being associated with a topic k; and wherein: the predictive code length characterizes a minimum code length required to compress the new word in a sequentially updating lossless compression; common words have a low value of the predictive code length; and unlikely words have a high value of the predictive code length.

The one or more predictive features can include a relative predictive code length feature characterized by:

\tilde{L}_{w}=−log \hat{p}(w|θ)−log \hat{p}(w)

wherein:

$$- log \hat{p} ( w \vert θ ) = - log ( {\sum }_{k} {φ}_{m , k} {θ}_{k} )$$

L_{w} is a relative predictive code length of a new word w; \hat{p}(w|θ) is a conditional probability associated with new word w and topic vector θ; Φ_{m,k} is a probability of a word m being associated with a topic k; and \hat{p}(w) is a baseline probability of the new word determined regardless of data associated with a specific transacting entity.

The one or more predictive features can include a distribution distance feature comprising at least one of: Kullback-Leibler divergence, Hellinger distance, Euclidean distance, mean absolute deviation, maximum absolute deviation, and Jensen-Shannon divergence. The one or more predictive features can include topic-distribution components and associated functions.

The one or more predictive features can be provided as input to two or more predictive models that generate the score and that are implemented in series. The one or more predictive models can include two or more of: logistic regression models, artificial neural network models, decision trees, support vector machines, and scorecard models. The initiation of the score can occur over a network. The network can be the Internet.

The first number of words can characterize one or more payment transaction characteristics including merchant category codes, merchant postal codes, discrete transaction amount, and discrete transaction time. The first number of words can characterize characteristics unique to merchants. The unique characteristics can include postal codes of clients of the merchants, discrete credit lines of credit cards of the clients, and a bank identity number portion of a primary account number. The first number of words can characterize transaction types, point of sale (POS) entry mode, foreignness of transactions, and localness of transactions. The first number of words can characterize accessed internet browsers, sequences of one or more products clicked, and time spent in viewing each product. The first number of words can characterize transaction times, transaction amounts, client postal codes, client credit lines, client cash advance limits, and bank identification numbers of primary account numbers. The first number of words can characterize types of browsers, version identifiers, language settings, internet protocols, subnet addresses, discrete online session lengths, and sequence of button clicks. The first number of words can characterize discrete revolving credit balances, relative revolving balance limits, discrete payment ratio that is a ratio of payment to most recent due amount, a discrete payment delay that is a number of days from billing to payment, a number of recent consecutive delinquent cycles, a total number of delinquent cycles, and finance charges. The first number of words can characterize specific item codes, item categories, geographical data, a pattern of time of access, sequences of views of web pages, sequences of views of sections in web pages, and sequences of views of items in web pages.

In yet another interrelated aspect, a method includes receiving data characterizing at least one transaction; calculating, using a topic probability mixture vector that is updated when the data is received and that is generated by a latent Dirichlet allocation (LDA) model, values of one or more predictive features; and scoring, based on the values of the one or more predictive features, the at least one transaction.

In optional variations, one or more of the following additional features can be included in any feasible combination. The latent dirichlet allocation (LDA) model can be trained on historical data comprising historical transactions. The topic probability mixture vector can include values. A count of the values can be equal to a count of topics associated with the historical data, each value characterizing a probability of association of a word from a corresponding transaction with a corresponding topic.

The updating of the topic probability mixture vector can include initializing a first vector characterizing a multiple of the topic probability mixture vector; applying a time delay to the first vector to modify the first vector; determining, from the received data, new words characterizing one or more new transactions; computing an initial estimate of the topic probability mixture vector as

$${θ}_{k} = \frac{{ζ}_{k}}{{\sum }_{k = 1}^{K} {ζ}_{k}} ,$$

θₖ is a k^{th} value in the topic probability mixture vector θ, ζ being the modified first vector, and ζₖ being k^{th} value in the modified vector ζ; computing a second vector γ as γ_{n,k}=p(tₖ|wₙ,θ), wherein

$$p ( {t}_{k} \vert {w}_{n} , θ ) = \frac{p ( {w}_{n} \vert {t}_{k} , θ ) p ( {t}_{k} \vert θ )}{p ( {w}_{n} \vert θ )} = \frac{{φ}_{m , k} {θ}_{k}}{p ( {w}_{n} \vert θ )} ,$$

m is an index of a current word in the topic matrix φ, θₖ being k^{th} element of the topic probability mixture vector θ, and denominator being computed as

$$p ( {w}_{n} \vert θ ) = {\sum }_{k = 1}^{K} {φ}_{m , k} {θ}_{k} ;$$

computing a temporary vector τ as:

$${τ}_{k} = {ζ}_{k} + {\sum }_{n = 1}^{N} {γ}_{n , k} ;$$

updating, using the temporary vector τ, the topic probability mixture vector as

$${θ}_{k} = \frac{{τ}_{k}}{{\sum }_{k = 1}^{K} {τ}_{k}} ;$$

modifying the second vector γ as γ_{n,k}=p(tₖ|wₙ,θ) to enhance the second vector; updating the modified first vector by:

$${ζ}_{k} ⇐ {ζ}_{k} + {\sum }_{n = 1}^{N} {γ}_{n , k} ,$$

wherein ζₖ on right side is a prior value of ζₖ, ζₖ on left side is an updated new value of ζₖ; re-updating the modified first vector by:

$${ζ}_{k} ⇐ \frac{B \times {ζ}_{k}}{s} ,$$

wherein

$$s = {\sum }_{k = 1}^{K} {ζ}_{k} ,$$

B is an upper bound characterizing a time window for collecting the historical data; and computing a final value of the topic probability mixture vector as

$${θ}_{k} = \frac{{ζ}_{k}}{{\sum }_{k = 1}^{K} {ζ}_{k}} , {ζ}_{k}$$

being the further re-updated value of the modified first vector. The final value of the topic probability mixture vector can be the updated topic probability mixture vector. The modified first vector can be obtained by multiplying the first vector by exp(−Δ/T), exp can be an exponential function, Δ can be a time difference between an older transaction and a newer transaction, and T can be a time constant.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, observed data (that is, “words” characterizing observed data, as used herein) associated with each transaction can be represented with a small number of statistically accurate dimensions compared to the original, large dimensionality of the space of possible words. Such a reduction in dimension can increase computational speed, and can require less memory to store data associated with observed words.

Further, detection of risk associated with a transaction is described. This detection can be accurate, computationally efficient and cost efficient, as such a detection is based on a lower dimensional topic space (as compared to conventional techniques) that is achieved by intelligent reduction of dimensions. More specifically, such a detection of risk can require significantly less time than conventional implementations, as observed data (that is, “words” characterizing observed data, as used herein) associated with all the historical data does not need to be stored and instead, a statistically accurate summary can be stored in a lower-dimensional space. Thus, all the calculations associated with an initial detection are not required to be re-performed, thereby determining the risk in a timely and cost-effective manner.

Moreover, the reduction of dimensions described herein can be sensitive to collective patterns of behavior observed across the entire data-set rather than just the profiled entity itself. This can allow profiling of more detailed and predictive information than conventional profiles, thereby providing increased predictive power by making use of global patterns of typical and atypical behavior.

The details of one or more variations of the subject matter described herein are set forth in the accompanying drawings and the description below. Other features and advantages of the subject matter described herein will be apparent from the description, the drawings, and the claims.

### DESCRIPTION OF DRAWINGS

FIG. 1A is a first flow diagram illustrating scoring of at least one transaction;

FIG. 1B is a second flow diagram illustrating generation of a model and scoring of at least one transaction;

FIG. 2 is a diagram illustrating a design-time system for generating an initial topic model and subsequently generating a probability matrix and a topic probability mixture vector;

FIG. 3 is a diagram illustrating a run-time system for implementing a selected topic model, updating the topic probability mixture vector, obtaining values for predictive features, and scoring one or more transactions;

FIG. 4 is a flow diagram illustrating updating of a topic probability mixture vector when data characterizing a new transaction is received;

FIG. 5 is a graph illustrating a curve showing a variation of risk with respect to a variation in value of a predictive feature;

FIG. 6 is a graph illustrating a receiver operations curve between fraudulent transactions score distribution and legitimate transactions score distribution; and

FIG. 7 is a graph illustrating a curve with Latent Dirichlet Allocation (LDA) derived features, and a curve without LDA features.

### DETAILED DESCRIPTION

The subject matter described herein relates to scoring transactions associated with an entity so as to determine risk and/or fraud associated with the transactions. The entity can be one of: a customer, a merchant, a bank account, a sales channel (for example, an internet sales channel), a product, and other entities.

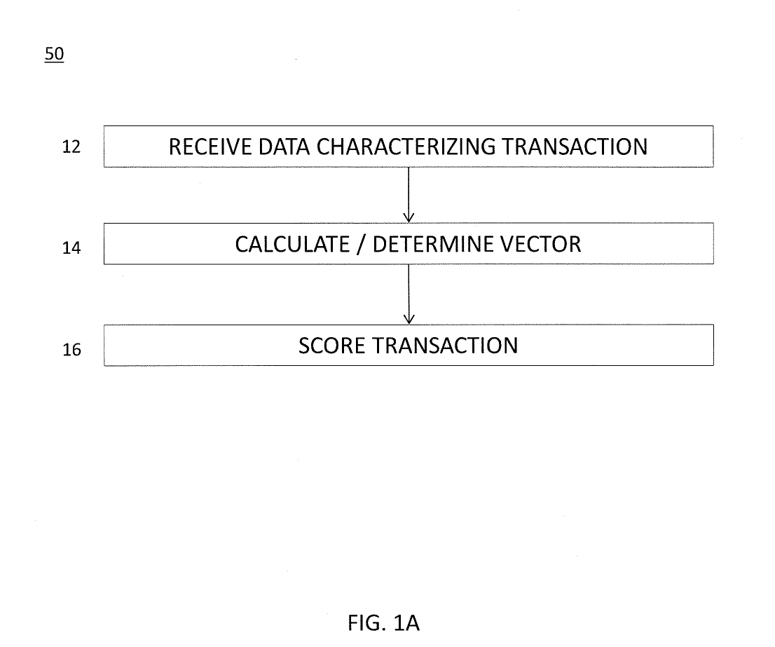

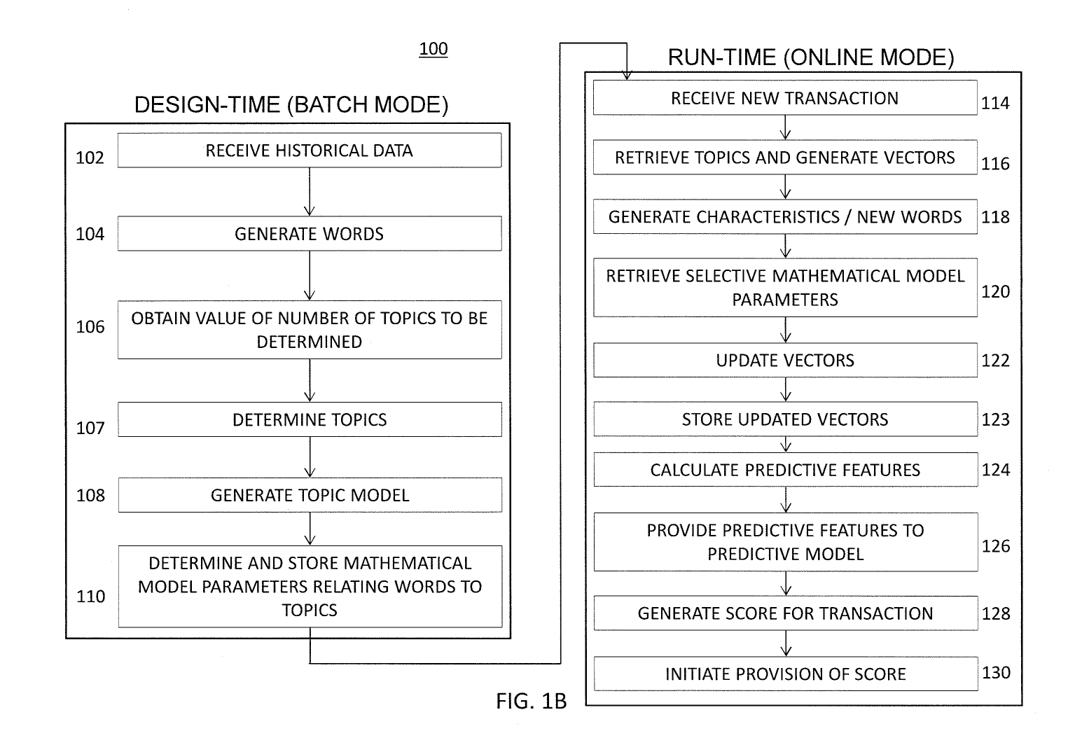

FIG. 1A is a first flow diagram 50 illustrating scoring of at least one transaction. At least one transaction can be received at 12. A topic probability mixture vector can be generated by a topic model trained on historical data including historical transactions. The topic probability mixture vector can be updated when the new transaction is received. Using the updated topic probability mixture vector, values of one or more predictive features can be calculated at 14. Based on the values of the one or more predictive features, the at least one transaction can be scored.

FIG. 1B is a second flow diagram 100 illustrating generation of a model and scoring of at least one transaction. 102, 104, 106, 108, and 110, can be performed in a design-time (herein, also referred to as a batch-mode) and 114, 116, 118, 120, 122, 123, 124, 126, 128, and 130 can be performed in a run-time (herein, also referred to as an online-mode).

Historical data can be received, at 102. The historical data can include data associated with transactions between a first transacting entity and a second transacting entity that has a profile. In one example, the first transacting entity can be one or more transacting partners, such as merchants; and the second transacting entity can be one or more account holders, such as customers of the merchants. The historical data can be selected for a variable time period, such as the past 2 months, the past 6 months, the past 1 year, the past 2 years, the past 10 years, or any other time period. Such a time period is, herein, also referred to as an upper bound.

From the received historical data, the characteristics generator can generate, at 104, characteristics associated with each transaction. The characteristics can characterize various aspects of the observed transaction data or combinations of these aspects. These characteristics can also be referred to as “words.”

The generated words can be categorical. The categorical generated words can characterize categorical data directly or indirectly after transformation. Further, the generated words can characterize continuous numerical data after discretization in both (or at least one of, in some implementations) historical and online transactional data. More specifically, the words can be directed to one of more characteristics associated with historical transactions in the historical data.

A “word” can characterize observed data, and a “document” can characterize a sequence of words associated with a transacting entity, as used herein. Some examples of words are noted below. In one example, the words can characterize one or more payment transaction characteristics including merchant category codes, merchant postal codes, discrete transaction amount, discrete transaction time, and other characteristics. Further, the words can characterize characteristics that can be unique to merchants, such as at least one of: postal codes of clients of the merchants, discrete credit lines of credit cards of the clients, a bank identity number portion of a primary account number (PAN), and other characteristics. In another example, the words can characterize one or more of: transaction types, point of sale (POS) entry mode, foreignness of transactions, localness of transactions, and other characteristics. Furthermore, the words can characterize one or more of: accessed internet browsers, sequences of one or more products clicked, time spent in viewing each product, and other characteristics. Further, the words can characterize one or more of: transaction times, transaction amounts, client postal codes, client credit lines, client cash advance limits, bank identification numbers of primary account numbers (PANs), and other characteristics. Additionally, the words can characterize at least one of: types of browsers, version identifiers, language settings, internet protocols, subnet addresses, discrete online session lengths, sequence of button clicks, and other characteristics. Further, the words can characterize one or more of: discrete revolving credit balances, relative revolving balance limits, discrete payment ratio that is ratio of payment to most recent due amount, discrete payment delay that is a number of days from billing to payment, number of recent consecutive delinquent cycles, total number of delinquent cycles, finance charges, and other characteristics. In another example, the words can characterize at least one of: specific item codes, item categories, geographical data, pattern of time of access, sequences of views of web pages, sequences of views of sections in web pages, sequences of views of items in web pages, and other characteristics. These examples of categorized words are described in more detail further below.

A numerical value can be obtained at 106. The numerical value can characterize the number of desired topics that are to be determined. The topics can characterize purchase patterns determined from the historical data. For example, a topic can be a common behavior of consumers purchasing gasoline and groceries together. Another example of a topic can be a common pattern of consumers making online purchases of books and music. Other examples of topics can also be possible. Based on the numerical value, topics with a count equal to the numerical value can be determined, at 107, by performing a mapping between the generated words and topics, which can be pre-defined in some implementations. Such a mapping can be performed by a topic-word mapping model.

Based on the generated words and the determined topics, a topic model can be generated at 108. The topic model can be a probabilistic mapping between words and associated topics. The probabilistic mapping includes inferred probabilities between words and topics. In one example, a probability can characterize likelihood that a particular word is included in a particular topic. In some implementations, these probabilities can be arranged in a matrix, number of rows of which can equal the dimensionality of the space of generated words and number of columns of which can equal a number of the determined topics. Each cell in the matrix can include/represent a probability of a corresponding word being included in a corresponding topic. The topic model can be a latent Dirichlet allocation (LDA) model. In some alternate implementations, more than one topic models can be generated, wherein each topic model can correspond to words of different classes generated from the historical data. Each topic model can be associated with profiles stored for a transacting entity.

From the topic model, mathematical model parameters can be determined at 110. In some implementations, the mathematical model parameters can simply be the probabilities of the matrix noted above. In other implementations, the mathematical model parameters can be values (for example, numerical values) from which the probabilities of the above-noted matrix can be derived using one or more mathematical transformations. The mathematical parameters can be stored, at 110, for later use during run-time.

Data characterizing a new transaction can be received at 114. The new transaction can be between a first transacting entity and a second transacting entity that has a profile. In one example, the first transacting entity can be one or more transacting partners, such as merchants; and the second transacting entity can be one or more account holders. The new transacting partners can possibly be different from the transacting partners considered in the design-time historical data, and the new account holders can possibly be different from the account holders considered in the design-time historical data.

Topics that are associated with this profiled transacting entity and that are stored in design-time can be retrieved at 116. Using the retrieved topics, topic probability mixture vectors can be generated at 116. Although generation of topic probability mixture vectors is described here in run-time, in some other implementations, the topic probability mixture vectors can be first generated in design-time, and then in run-time, relevant topic probability mixture vectors can be selected. For computational convenience, the distribution of topics can be represented as a non-normalized multiple of a topic probability mixture vector, which is also referred to herein as ζ.

Characteristics can be generated, at 118, from the transaction data, and new words describing aspects of the transaction can be generated from the characteristics. This generation of words can be computationally performed by using techniques and/or algorithms that are similar to the techniques and/or algorithms described above with respect to 104 in the design-time phase.

When the data characterizing the new transaction is received from a particular time period, in some implementations, words from most recently occurring transactions in a sequence can be allocated more importance (for example, weight) and words from previously occurring transactions can be allocated less importance (for example, weight). Such an effective disregarding (by allocating less importance) of words from transactions earlier in the sequence can be referred to as an event-based decay when the interval between events is measured by a number of intervening events.

Further, in some implementations, words from most recent transactions in actual time can have more importance (for example, weight) and words from old transactions can have less importance (for example, weight). Such a differing importance/weight of words can be referred to as a time-based decay, when the time based events is measured in variable numerical units, such as that derived from transaction time data fields in the observed data. Combinations of intrinsic and externally determined definitions of time are possible. The decrease in importance of words when one moves from newer transactions to older transactions can be proportional to exp(−Δ/T), wherein exp can be an exponential function, Δ can be the time difference between the older transaction and the newer transaction, and T can be a time constant. Small values of T can cause a quick decrease in importance of older transactions (that is, older transactions may be forgotten quickly), and large values of T can cause a slow decrease in importance of older transactions (that is, older transactions may be forgotten slowly).

These event-based decay and time-based decay can be advantageous over a configuration where same importance is associated with all words obtained from the historical data. A profiled entity may store one or more multiple vectors which are updated using one or more values of T. Using different values of T for updates for more than one vectors ζ can be advantageous to detect differences in short-term compared to long-term behavior.

Based on the new words, and mathematical model parameters stored at 110, mathematical model parameters that correspond to the new words can be retrieved at 120. The parameters can include the probabilistic mapping between topics and the values of the new words.

Based on the generated new words, associated allocated weights/importance, the stored multiples ζ, and the retrieved model parameters, one or more values of the topic probability mixture vector can be updated at 122. The updated topic probability mixture vectors can be stored separately from the previous topic probability mixture vectors so that at a later time, both the previous/old topic probability mixture vectors and updated topic probability mixture vectors can be retrieved. Thus, the update can occur based on the stored multiple and the new words in the new transaction, rather than all the historical words in historical transactions. Thus, the historical words may not be required to be stored in memory, thereby saving memory space and optimizing computing resources. An additional topic probability mixture vector corresponding to the instantaneously observed word may also be generated without using any stored multiple ζ.

Values of the updated topic probability mixture vectors or their multiples can be stored, at 123, with the profile of the profiled transacting entity. These stored probabilities can be later retrieved at 116 for a future transaction involving this profiled transacting entity. The profiled transacting entity can be to an account or a customer involved in the new transaction.

Based on the values in the topic probability mixture vectors considered both prior to and subsequent to the update at 122, values of one or more predictive features can be calculated at 124. The one or more predictive features can include one or more of: predictive code length features, relative predictive code length features, distribution distance features, features characterizing topic-distribution components and associated functions, and other features.

The predictive code length feature can be characterized by:

$${L}_{w} = - log \hat{p} ( w \vert θ ) = - log ( {\sum }_{k} {φ}_{m , k} {θ}_{k} ) ,$$

wherein: L_{w} is a predictive code length of a new word w; \hat{p}(w|θ) is a conditional probability associated with new word w and topic probability mixture vector θ; and Φ_{m,k} is a probability of a word m being associated with a topic k. The predictive code length can characterize a minimum code length required to compress the new word in a sequentially updating lossless compression. Unlikely/uncommon words can have a high value of the predictive code length, and common words can have a low value of the predictive code length.

The relative predictive code length feature can be characterized by: \tilde{L}_{w}=−log \hat{p}(w|θ)−log \hat{p}(w), wherein:

$$- log \hat{p} ( w \vert θ ) = - log ( {\sum }_{k} {φ}_{m , k} {θ}_{k} ) ;$$

L_{w} can be a relative predictive code length of a new word w; \hat{p}(w|θ) can be a conditional probability associated with new word w and topic probability mixture vector θ; Φ_{m,k} can be a probability of a word m being associated with a topic k; and \hat{p}(w) can be a baseline probability of a word determined from the historical data, regardless of any association with the profiled entity.

The distribution distance feature can include at least one of: Kullback-Leibler divergence, Hellinger distance, Euclidean distance, mean absolute deviation, maximum absolute deviation, and Jensen-Shannon divergence.

The calculated predictive features, as described above, can be provided, at 126, as input to one or more predictive models. The one or more predictive models can also be provided with other features (for example, predetermined features) from other sources besides receiving the calculated predicted features. The one or more predictive models can include one of more of the following in any combination: at least one logistic regression model, at least one artificial neural network model, at least one decision tree, at least one support vector machine, and at least one scorecard model.

Based on the values of the provided features, a predictive model can generate, at 128, a score for the new transaction. The score can indicate a likelihood of risk and/or fraud associated with the transaction. In some implementations, a single predictive model can be used to generate a final score. In other implementations, one or more predictive models can be used to generate subsidiary scores that can be provided to another predictive model that can generate a final score.

A provision of the final score can be initiated at 130. The final score can be provided to any entity, such as a merchant, a consumer, or any third party other than merchant and consumer. The final score can be provided on a terminal device of the entity, such as a computer, tablet computer, cellular phone, and/or any other device. On the terminal device, the score can be displayed on a graphical user interface. In addition to the display of the score, other diagrams, such as graphs, pie charts, and other figures, can be displayed so as to display one or more patterns of variations in the prediction. The score can be provided to the terminal device over the internet. Although internet has been described, other communication networks can alternatively be used, such as a local area network, wide area network, metropolitan area network, Bluetooth network, infrared network, communication network, cellular network, and other networks.

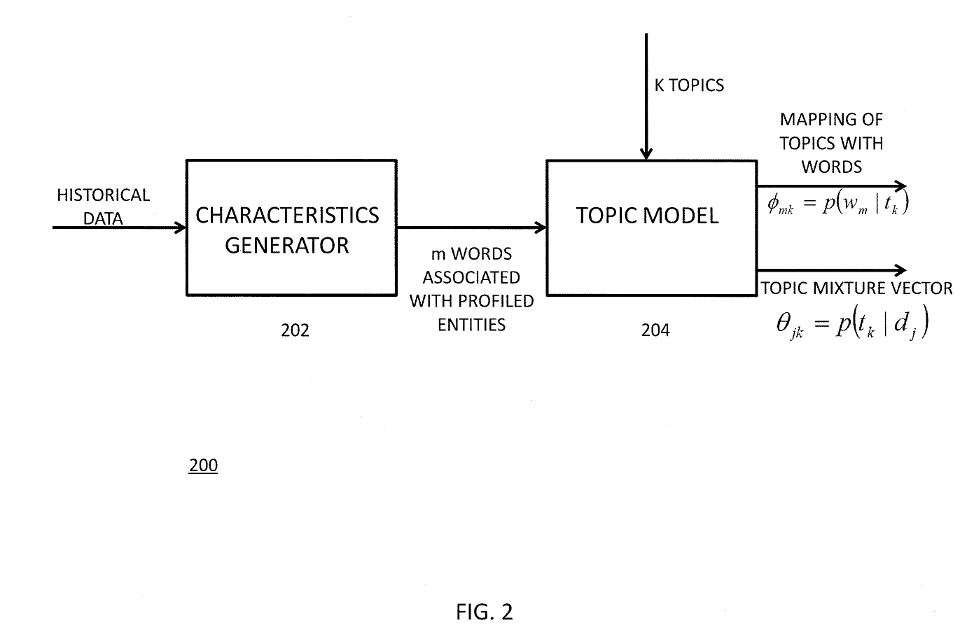

FIG. 2 is a diagram 200 illustrating a design-time system for generating an initial topic model (for example, a LDA model) and subsequently generating a probability matrix and topic probability mixture vector θ. A characteristics generator 202 can receive historical data including a plurality of historical transactions between a first transacting entity and a second transacting entity that has a profile. In one example, the first transacting entity can be one or more transacting partners, such as merchants; and the second transacting entity can be one or more account holders. The characteristics generator 202 can determine m words from the historical data. The m words can be chosen from natural language words, which, after common insignificant words (for example, articles such as “a”, “an”, “the,” and other insignificant words) have been removed from historical data, are most represented in most topics with significant probabilities and in the remaining topics with low probabilities. The words can also be chosen from non-linguistic features associated with data sequences on an entity, as noted above. The words can be represented computationally as integers, and take on any of M possible values, such as values between 1 and M inclusively.

J sequences (also referred to herein as “documents”) associated with profiled transacting entity and the choice of the number of desired topics K, can be used to generate a topic model 204, such as a LDA model. The topic model can yield a probability matrix Φₘₖ, and a topic probability mixture vector θ_{k;j} for each document. Mathematically, Φₘₖ=p(wₘ, tₖ). That is, Φₘₖ can characterize a probability of the word m (which can take values between 1 and M inclusively) being selected if a word were randomly drawn from topic tₖ (indexed by k, which can take values between 1 and K with both 1 and K being inclusive). The sum of probabilities in each column of the Φₘₖ matrix sums to one, as sum of probabilities of mutually exclusive events is one. Each topic probability mixture vector θ_{k;j} can include K values. As K (that is, number of topics) can be significantly lower than the M (that is, number of possible words), it can be computationally efficient to store such a topic probability mixture θⱼ. θ_{k;j} is the probability vector estimated at design-time for the entity represented by the document in the historical data. Mathematically, θ_{k;j}=p(tₖ, dⱼ). That is, θ_{k;j} can characterize a probability weight that associates a document having an index j with a topic having an index k.

The boxes shown in diagram 200 can refer to separate software and/or hardware modules. In one implementation, the different software and/or hardware modules can be implemented by a single computing system that includes one or more computers. In another implementation, the different software modules can be executed by separate computing systems, each of which can include one or more computers. In some implementations, one or more of the separate computing systems can be implemented distantly, and these distant computing systems can interact over a communication network, which can be the internet, an intranet, a local area network, a wide area network, a Bluetooth network, or the like.

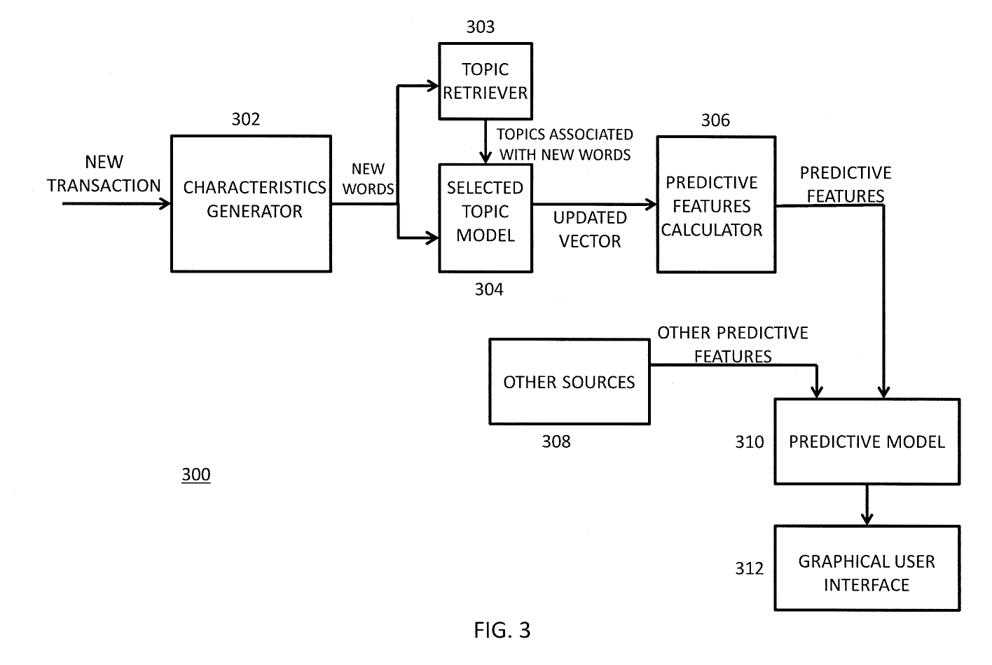

FIG. 3 is a diagram 300 illustrating a run-time system for implementing a selected topic model, updating the topic probability mixture vector, obtaining values for predictive features, and scoring one or more transactions. A characteristics generator 302 can receive a new/current transaction. In response, the characteristics generator 302 can determine new words (that is, words other than those obtained from historical data) in the new transaction.

When there are multiple topic models, one topic model can be selected to obtain a selected topic model 304. The selection can be based on the upper bound (as described above) of time for historical data, as various topic models can correspond to respective values of the upper bound.

Based on the new words, a topic retriever 303 can retrieve, from topics stored during design-time, topics that are associated with the new words.

Based on values of the stored multiple ζ, an existing topic probability mixture vector can be generated. Based on the new words and the retrieved selected topics, the existing topic probability mixture vectors can be updated. The updated and previous/old topic probability mixture vectors can be stored separately so that both can be available at a later time. The process can be repeated for all topic models associated with varying event and time-decay parameters and for all topic models across varying choices of word definitions and their associated topic models.

Both the previous and updated topic probability mixture vectors θⱼ can be provided to a predictive features calculator 306. The predictive feature calculator 306 can use the topic probability mixture vectors θⱼ to generate predictive features, such as one or more of: predictive code length features, relative predictive code length features, distribution distance features, features characterizing topic-distribution components and associated functions, and other features, as noted above. In some implementations, the generated features can be calculated both before the update and after the update of the topic probability mixture vector.

These calculated predictive features, optionally along with other predictive features from other sources 308, can be provided to a predictive model 310, which can be one or more of: logistic regression models, artificial neural network models, scorecard models, and other models. The predictive model 310 can generate a score for each transaction. In some implementations, more than one predictive model can be used in series such that the last predictive model in the series can generate the final score while previous predictive models can generate subsidiary scores. While the predictive model is described to generate score, in other implementations, other diagrams, such as graphs, pie charts, and the like can also be generated so, wherein such diagrams can indicate patterns of variations in the prediction.

The generated score and/or other generated diagrams can be displayed on a graphical user interface 312 that can be implemented on a terminal device connected over a network, such as internet.

The boxes shown in diagram 300 can refer to separate software and/or hardware modules. In one implementation, the different software modules can be executed by separate computing systems, each of which can include one or more computers. In some implementations, one or more of the separate computing systems can be implemented distantly, and these distant computing systems can interact over a communication network, which can be the internet, an intranet, a local area network, a wide area network, a Bluetooth network, or the like.

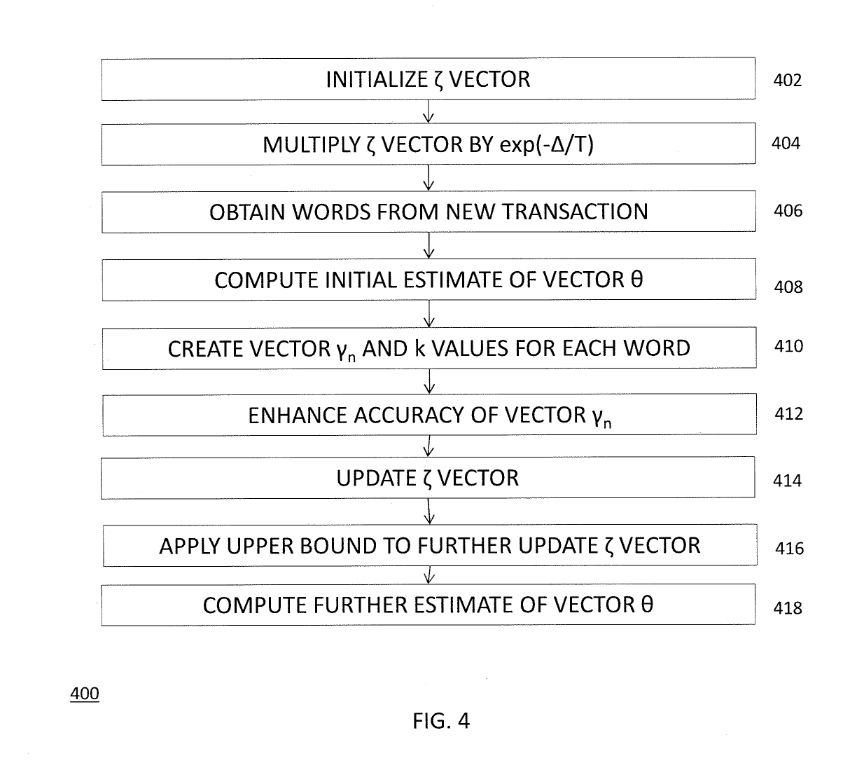

FIG. 4 is a flow diagram 400 illustrating updating of a topic probability mixture vector when data characterizing a new transaction associated with an entity is received. The entity can be one of: a customer, a merchant, a bank account, a sales channel (for example, an internet sales channel), a product, and other entities.

For each entity being profiled, word space and choice of time there can be a ζ vector, which is herein also referred to as the multiple, which can be initialized, at 402, so that each of the K values in ζ can be set to α, where α can be a positive constant that can apply a Dirichlet prior to the probabilities in θ. This initialization can be performed only once for each vector, and before any of that entity's words may be processed. Other alternate initializations are possible such as using the global distribution of topics estimated from historical data, or values of the specific topic distribution associated with the entity determined at design time.

For each transaction that involves the entity being profiled, the following can be performed:

For time-based decay only, the ζ vector can be multiplied, at 404, by exp(−Δ/T), where Δ can be the time between the current and previous transactions, and T can be a time-constant. This may not be performed for the first transaction of the profiled entity, because Δ may not be defined.

The one or more words can be obtained, at 406, to be added to the profile from this transaction. These words can be referred as w₁ through w_{N}, where N can be the number of words from this transaction.

The initial estimate of the topic probability mixture vector θ can be computed, at 408, as

$${θ}_{k} = \frac{{ζ}_{k}}{{\sum }_{k = 1}^{K} {ζ}_{k}} ,$$

where θₖ can be the k^{th} value in the topic probability mixture vector θ and ζₖ can be the k^{th} value in the vector ζ.

For each word wₙ, with n between 1 and N, a vector γₙ of K values can be created at 410. The k^{th} value in γₙ can be the probability of the corresponding topic, tₖ, given the word wₙ and the topic probability mixture vector θ. Mathematically, γ_{n,k}=p(tₖ|wₙ,θ). This probability can be computed by implementing Bayes theorem such that

$$p ( {t}_{k} \vert {w}_{n} , θ ) = \frac{p ( {w}_{n} \vert {t}_{k} , θ ) p ( {t}_{k} \vert θ )}{p ( {w}_{n} \vert θ )} = \frac{{φ}_{m , k} {θ}_{k}}{p ( {w}_{n} \vert θ )} ,$$

where m can be the index of the current word in the topic matrix φ, θₖ can be the k^{th} element of the topic probability mixture vector θ, and the denominator can be computed as

$$p ( {w}_{n} \vert θ ) = {\sum }_{k = 1}^{K} {φ}_{m , k} {θ}_{k} .$$

The accuracy of the vectors γₙ can be enhanced, at 412, by optionally iterating the following one or more times: The estimate of topic probability mixture θ can be updated by first computing a temporary vector τ of K values. The k^{th} value in τ can be computed as:

$${τ}_{k} = {ζ}_{k} + {\sum }_{n = 1}^{N} {γ}_{n , k} .$$

Once the entire vector τ is computed, each of the k values in the topic probability mixture θ can be updated with

$${θ}_{k} = \frac{{τ}_{k}}{{\sum }_{k = 1}^{K} {τ}_{k}} .$$

For each word wₙ, with n between 1 and N, the K values of γₙ can be updated. The k^{th} value in γₙ can be the probability of the corresponding topic tₖ given the word wₙ and the topic probability mixture vector θ. Mathematically, γ_{n,k}=p(tₖ|wₙ,θ). The probability referred in this mathematical equation can be computed as

$$p ( {t}_{k} \vert {w}_{n} , θ ) = \frac{p ( {w}_{n} \vert {t}_{k} , θ ) p ( {t}_{k} \vert θ )}{p ( {w}_{n} \vert θ )} = \frac{{φ}_{m , k} {θ}_{k}}{p ( {w}_{n} \vert θ )} ,$$

where m can be the index of the current word in the topic matrix φ, θₖ can be the k^{th} element of the topic probability mixture vector θ, and the denominator can be computed as

$$p ( {w}_{n} \vert θ ) = {\sum }_{k = 1}^{K} {φ}_{m , k} {θ}_{k} .$$

The vector ζ can be updated, at 414, by replacing the k^{th} value in ζ by value determined by the following mathematical equation:

$${ζ}_{k} ⇐ {ζ}_{k} + {\sum }_{n = 1}^{N} {γ}_{n , k} ,$$

wherein the ζₖ on the right side of the arrow can be the prior value of ζₖ and the ζₖ on the left side of the arrow can be the new value of ζₖ. The sum over k of the values ζₖ can be increased by the number (N) of words that were processed in this transaction.

For event-based decay only, a positive upper bound B can be applied, at 416, on the sum of the values in vector ζ. The upper bound B can characterize the time period measured in number of events from which the historical data is obtained and used. The sum s can be computed as:

$$s = {\sum }_{k = 1}^{K} {ζ}_{k} .$$

If s<=B, then ζ may not be modified. If s>B, then the values ζₖ can be updated with the value computed using the following mathematical equation:

$${ζ}_{k} ⇐ \frac{B \times {ζ}_{k}}{s} .$$

Once this upper bound is reached, it can always be applied for each subsequent transaction. The effect of this can be that the words from older transactions can gradually contribute less/weakly to the vectors ζ, while the most recent words can continue to contribute more/strongly to ζ. This can cause the current estimate of the topic probability mixture vector θ to reflect the most recent behavior of the entity being profiled more strongly than behavior from many transactions before the current transaction, thereby allowing the profile to adapt as the behavior of the entity changes. Small values of B can cause the topic probability mixture vector to forget older transactions quickly while large values of B can cause the topic probability mixture vector to forget older transactions more slowly.

For the current transaction, the final estimate of the topic probability mixture vector can be computed, at 418, in accordance with the following equation:

$${θ}_{k} = \frac{{ζ}_{k}}{{\sum }_{k = 1}^{K} {ζ}_{k}} .$$

It can be possible to run multiple, parallel computations of the topic probability mixture vector with different values of the upper bound B and/or time-constant T. Each parallel computation can require a separate copy of the ζ vector. Each of the parallel computations can yield different estimates of the topic probability mixture vector. Some estimates can more heavily reflect the most recent transactions as compared to older transactions. Other estimates can more heavily reflect longer term behavior of the entity's transactions as compared to shorter term behavior of those transactions. These different estimates of the topic probability mixture vector can be compared to detect changes in behavior of the profiled entity.

Implementation of Topic Models (for Example, LDA Models) for Risk Detection:

(A) Payment System Fraud Detection:

For payment system fraud detection, topic models can be built from different perspectives by profiling different entities. For each kind of profile entity, different, but sometime overlapping, sets of basic vocabularies and composited sets of vocabularies formed using the basic vocabularies can be constructed as follows.

(B) Primary Account Number (PAN) Perspective:

When constructing topic models for a payment system, one entity characterized by the profile can be the primary account number (PAN). Payment transaction characteristics that can be used to construct vocabularies can include:

(B.1) Merchant Category Code (MCC): merchant category code (MCC) can be used as it is with full resolution. Alternatively, similar merchant category codes (MCCs) can be grouped together to produce a smaller vocabulary.

(B.2) Merchant postal codes, augmented with country codes. For example, code 840-921 can be assigned to transactions involving merchants located in zip codes starting with 921 (that is, zip codes in southern California), with the 840 being the country code for the United States. Special codes can be used to distinguish transactions occurring in foreign countries where merchant postal codes may not be readily available.

(B.3) Discretized transaction amount: transaction amount can be discretized using uniform boundaries over all transactions or discretized based on statistics, such as mean and standard deviation of the transaction amount for all transactions in the corresponding merchant category code (MCC).

(B.4) Discretized transaction time: finer one such as hour of week or coarse one such as work day, work day evening, weekend day, and weekend evening. In the cases with multi-year data, day of year can also be used to capture seasonal characteristics.

For each primary account number (PAN), based on vocabularies constructed from above primitives, a merchant category code (MCC) LDA model can be built to capture archetypal merchant category code (MCC) groups (for example, MCC topics) from a set of MCC documents (herein, a document is a sequence of words that characterize observed data) constructed for primary account numbers (PANs). Then, the sequence of merchant category codes (MCCs) from a single primary account number (PAN) can be decomposed into a mixture of the archetypal merchant category code (MCC) groups, which can be identified by their probabilities for “producing” each merchant category code (MCC).

Similar to above merchant category code (MCC) example, a postal code (for example, zip code) topic models can be built to model and to track geographic shopping patterns for individual primary account numbers (PANs). Additionally, a transaction time topic model can be built to model and track individual primary account number's (PAN's) temporal shopping pattern.

Other simpler transactions characteristics can be used to enrich the primary vocabularies constructed from above can include one or more of the following: foreignness of transactions (that is, whether a cross-border transaction, which can be assessed by determining if merchant country code is same as the card holder country code); localness of transactions (which can be obtained by determining whether the first three digits of the card holder postal zip codes are same as the first three digits of merchant post codes); transaction types: purchase, cash advance, or purchase with cash-back; and point of sale (POS) entry mode: keyed, swiped, chip, or online order, etc.

For example, continuing with the above merchant category code (MCC) example, composite documents (herein, a document is a sequence of words that characterize observed data) with a richer vocabulary of words can be constructed by taking Cartesian product of merchant category code (MCC) and point of sale (POS) entry mode. In this case, the composite vocabulary can include words such as “7276-E-commerce” which can identify that an online payment transaction occurred in a merchant providing “Tax Preparation Services” (according to 7276 merchant category code (MCC)). Topic models built based on such composite vocabulary can capture sophisticated multi-faceted shopping patterns that can escape topic models based on single-facet basic vocabularies.

(C) Merchant Perspective:

Merchants can be profiled to characterize shopping patterns of their clients. In this case, each merchant corresponds to a profile. Similar to primary account number (PAN) based vocabularies of words, the following can be used:

(C.1) Discretized transaction time: finer one such as hour of week or coarse one such as work day business hour, weekend evening, weekend sleeping hours, etc. In the cases with multi-year data, day of year can also be used to capture seasonal characteristics.

(C.2) Discretized transaction amount: transaction amount can be discretized using uniform boundaries overall all transactions or discretized based on statistics, e.g. mean and standard deviation of the transaction amounts for this merchant or for all transactions in the corresponding merchant category code (MCC).

Unique to merchants, vocabularies can be constructed from one or more of: postal codes of clients, discretized credit lines of client's cards (as a proxy for credit-worthy of clientele), bank identity number (BIN) portion of primary account number (PAN), and other characteristics.

Basic vocabularies constructed above for merchants can be enriched by one or more of: transaction types, point of sale (POS) entry mode, foreignness of transactions, localness of transactions, and other criteria.

Furthermore, in the case that fraud and charge-back information is timely available for merchants, separate topic models can be built using only fraud transactions, similar to topic models built using transactions of non-fraud primary account number (PAN)s, to capture characteristics of fraudulent transactions that occurred in individual merchants.

The detailed items for each transaction, such as identifiable stock keeping unit (SKU), can also be used to construct a vocabulary of words to profile each client's purchasing propensity in detail.

(D) Online Merchant Perspective:

In addition to other characteristics, certain characteristics unique to online transactions can be used to construct vocabularies, such as one or more of: accessing browsers, and sequences of product viewed (clicked) and time spent in viewing each product. These vocabularies can be enriched by considering the types (for example, computer, tablet, or mobile phone) of accessing devices.

(E) Automated Teller Machine (ATM) Perspective:

Similar to merchants where purchases are made, topic models can be built for ATMs, where cash can typically be withdrawn and a large portion of fraud crime can be committed. Vocabularies can be constructed similarly based on one or more of: transaction time, transaction amount, client postal codes, client credit line/cash advance limit, bank identification number (BIN) portion of accessing primary account number (PAN)s, and other characteristics. Separated topic models that use only the subset of fraud transactions can also be built if timely fraud information is available for individual ATMs.

(F) Device Perspective:

As technology advances, new payment media can become available. Mobile payment via near field communication (NFC) can be a promising alternative to traditional card method. Vocabularies constructed for primary account number (PAN) and merchants, as discussed herein can be applicable to profile devices.

(G) Online Banking Fraud Detection Perspective:

Another type of fraud effecting financial institutions can be online banking fraud. In addition to the vocabularies that can be constructed for primary account number (PAN) and merchants in general payment system fraud detection (for example, as noted above), other vocabularies that can be useful for online banking fraud detection can be constructed from one or more of: (i) Accessing Browsers identities and or mobile: type of browsers, version id, language setting; (ii) internet protocol (IP) and subnet address of the log-in computer/devices; (iii) Discretized online-session length; and (iv) Sequences of button clicks.

(H) Credit Risk Perspective:

Credit risk can include a possibility that legitimately acquired debt, such as a home mortgage, auto loan, or credit card debt, will not be paid off, and that the lender will lose the principle amount of the loan.

Profiling shopping pattern can also help better assess an entity's credit risk. For example, in a credit card account, a burst of a big ticket purchase activity in a short time period can tip off a pending default due to job loss. Hence, vocabularies constructed as in payment fraud detection can use the characteristics associated with purchase and cash transactions.

In addition, unique to credit risk assessment, billing and payment information can be used to construct useful vocabularies for credit risk assessment. Such billing and payment information can include one or more of: discretized revolving credit balance or relative revolving balance level (for example, normalized by credit limit); discretized payment ratio, which is ratio of payment to most recent amount due; discretized payment delay, which is number of days from billing to payment; number of most recent consecutive delinquent cycles (for example, usually months) and total number of delinquent cycles; finance charges, such as cash advance fee, late fee, and other charges; and other billing and payment data.

(I) Attrition Risk Perspective:

Vocabularies similar to those used in payment card fraud detection can also be used to predict the likelihood that the cardholder may stop using the card, thereby reducing the revenue generated by the financial institution issuing the card.

(J) Targeted Offering and Advertising Perspective:

In the case detailed and itemized information for purchase is available, vocabulary can be constructed based on such detailed information and corresponding LDA model can be built to profile usual shopping behaviors of customers. Useful data elements for profiling customer's behavior can include one or more of:

(J.1) Specific item code: both stock keeping unit (SKU) and universal product code (UPC) can be used to identify the purchased item.

(J.2) Item category: In a coarser granularity, merchandise can be grouped into categories to identify “kind of items” a customer may typically purchase. For example, all the different kinds can brands of detergent can be grouped into “Health and Personal Care” while all the fertilizer for plants and vegetables can be grouped into “Lawn and Garden.”

(J.3) Geographical: the customer's home location (for example, postal code), and in the case of multi-outlet retailers, the store's location.

(J.4) Specific item code: both stock keeping unit (SKU) and UPC can be used to identify items.

(J.5) Time of day, day of week, day of month, season of year: the particular time of day and time of week can characterize a customer's typical living and working patterns (for example, day job, night job, retired, parent) and thus, characterize the types of items a customer may want to buy. The day of the month can reflect influences from a “paycheck cycle” in that discretionary items can be viewed more favorably after a payday, whereas offerings on staple necessities can be attractive immediately prior to a paycheck. A strongly seasonal buyer can be a homeowner with a pool, an outdoorsman, or a heavy holiday shopper. Distinguishing these types of customers by using combination of item type and season can advantageously yield attractive offers.

(J.6) For e-commerce merchants: facts about sequences of web pages, sections and items viewed, in addition to actually purchased items.

Archetypical distributions can be inferred, by using a same token as used in generation of predictive features, from the set of all the sequences of merchandises purchased and browsed by customers in past. Then, for each individual shopper, shopper's archetype tracking mixture can be updated online and/or in real-time as the shopper's purchasing and browsing action progresses. Based on real-time updated archetype tracking mixture combined with static merchandise archetype distribution, the most likely merchandise-to-be-purchased can be offered with high precision while targeting the customer's interests.

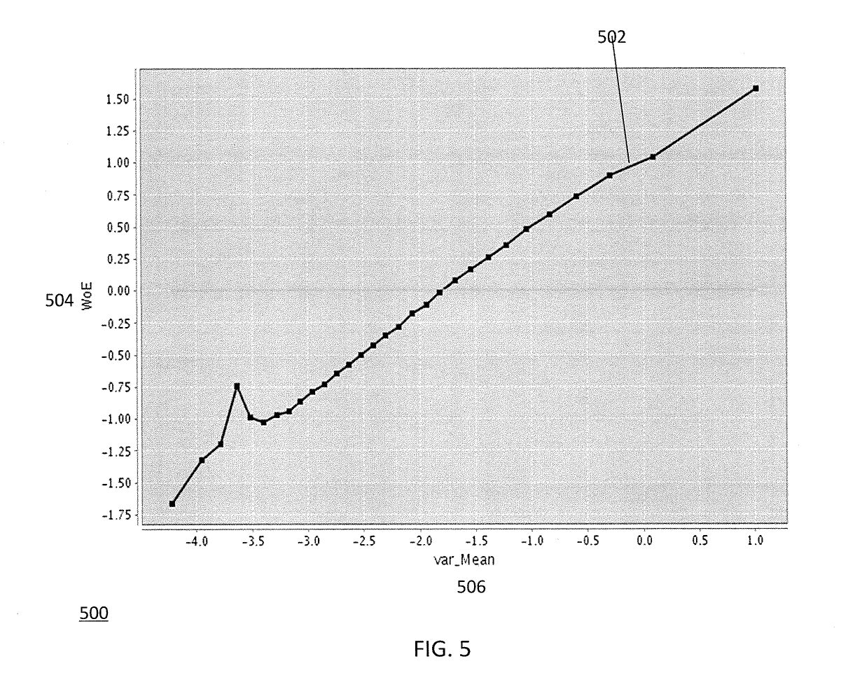

FIG. 5 is a graph 500 illustrating a curve 502 showing a variation of risk with respect to a variation in value of a predictive feature. The variation of risk can be characterized by weight of evidence (WoE) 504, and the predictive feature can be characterized by a mean variance (var_Mean) 506. The curve 502 can be almost linear over most of the range of the predictive feature 506. The curve 502 can indicate that features derived using LDA models can be significantly predictive.

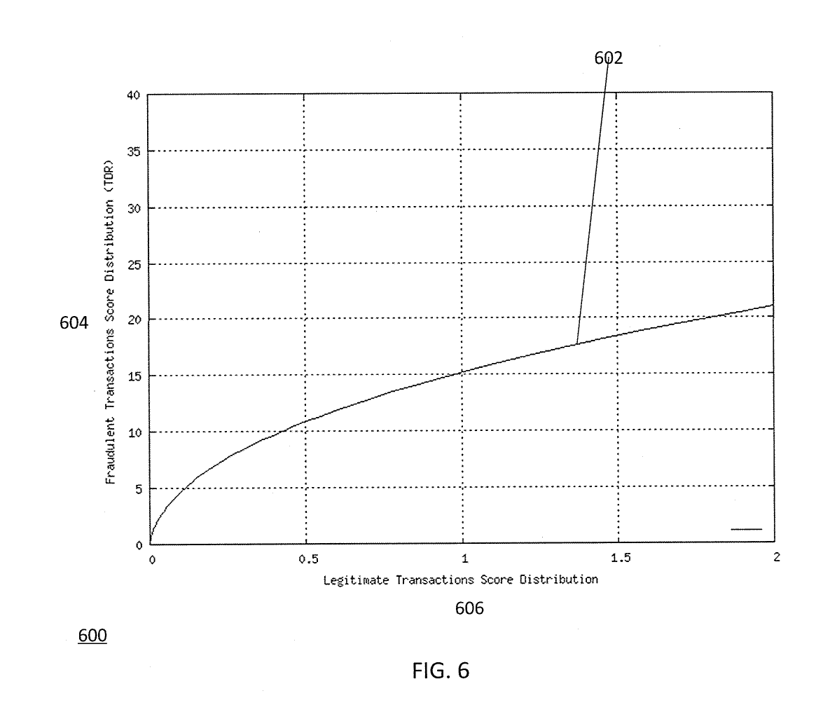

FIG. 6 is a graph 600 illustrating a receiver operations curve 602 between fraudulent transactions score distribution 604 and legitimate transactions score distribution 606.

To evaluate the effectiveness of LDA topic model derived predictive features, a statistical model can be trained using such features only. The graph 600 shows that at 2% transactions false positives (for example, non-fraud transactions mistakenly flagged as fraudulent), the trained predictive model (for example, neural network model) can detect more than 20% of true fraudulent transactions.

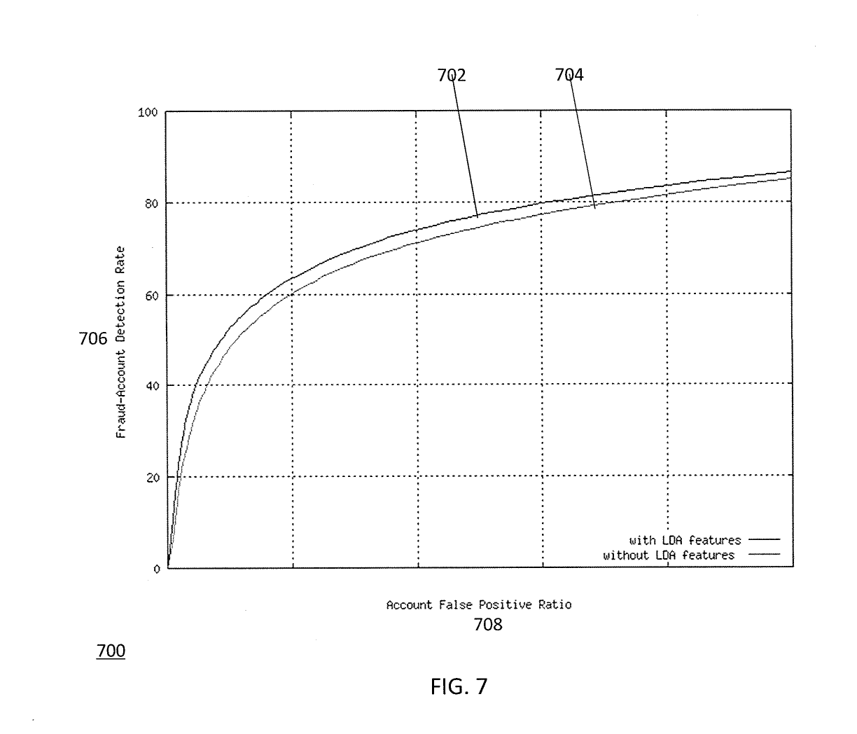

FIG. 7 is a graph 700 illustrating a curve 702 with LDA derived features, and a curve 704 without LDA features. It may be noted that while LDA has been described, other topic models can also be used herein. The curves 702 and 704 can be plotted between fraud account detection rate 706 and account false positive ratio 708. The graph 700 shows that the fraud detection is better when the LDA features are used as compared to when the LDA features are not used.

Thus, LDA derived features can provide extra predictive power on top of existing payment card fraud detections features. Predictive models (for example, neural network models) trained with LDA derived features added as extra inputs can outperform those predictive models without LDA features. The graph 700 demonstrates an improved fraud account detection rate 706 (for example, fraction of all accounts with detected fraud) performance with the LDA features added to the model. Account false positive ratio 708 can be the ratio of the number of non-fraud accounts that were falsely identified as fraudulent to the number of fraudulent accounts that were detected.

An Example Based on Merchant Category Codes (MCCs) for Payment Card Fraud Detection:

(A) Vocabulary

When merchant category codes are used to profile card holders' shopping patterns, the vocabulary can consist of the entire set of merchant category codes found in the transaction data. There can be approximately 500 merchant category codes (MCCs) in common usage in payment card transactions, after representing airlines and hotels as generic merchant category codes.

(B) Profiling Entity

For credit card fraud detection, primary account numbers (PANs) can be the profiling entities. Thus, each primary account number (PAN) can have a profile, and the words in the document (herein, a document is a sequence of words characterizing observed data) can be the Merchant Category Codes (MCCs) that have occurred in the transactions for that primary account number (PAN).

(C) Historical Data for Training the Topic Model

The transactions used to construct the profile for a particular primary account number (PAN) can include all transactions ever occurring on the primary account number (PAN). Alternately, the transactions can include only the transactions occurring after a certain date if the historical data is only available from that date forward. The historical data can include transactions as close as possible to the current time so that the models can learn the most current customer behavior. In a typical example, all transactions for all primary account number (PAN)s can be from a financial institution, which issues a card, for a period of 18 months, with the most current transactions occurring 4 months in the past. Such a lag can be caused due to the need to accurately determine which transactions are fraudulent and which transactions are legitimate, wherein such a determining can take several months. While the fraud/non-fraud status of each transaction may not be used in training the topic model, it can be necessary to evaluate the performance of topic models and can be required to train any supervised models that may use the topic-based features as inputs.

(D) Training a LDA Topic Model

For this example, assume that seven topics are used. Given the historical data and the resulting set of words for each primary account number (PAN), any LDA inference algorithm can be used to compute the topic-term matrix φ. If merchant category code (MCC) probabilities are inspected in each topic, topics with the following most probable merchant category codes (MCCs) can occur, although all merchant category codes (MCCs) occur in each topic with some non-zero probability. The name for the topics can come from human interpretation but the selection of the items in the topic can occur algorithmically.

(D.1) “Day to day living”: grocery stores, gasoline, clothing;

(D.2) “Youth/Student”: online books, online music, fast food, computer software, grocery stores;

(D.3) “Hurried life”: fast food, ground transportation;

(D.4) “Business travel”: hotels, airlines, ground transportation, restaurants, rental cars, fast food;

(D.5) “Vacation travel”: gasoline, hotels, restaurants, entertainment, fast food, airlines;

(D.6) “Health”: drug stores, medical equipment, health care provider;

(D.7) “Handyman”: auto parts, hardware, home improvement, nursery; and other merchant category codes (MCCs).

(E) Processing Transactions for Primary Account Number (PAN)

In this example, the profile memory for each primary account number (PAN) can include 7 floating-point numbers for the 7 probabilities in the primary account number's (PAN's) topic probability mixture vector. These values can be updated after each transaction occurring on that primary account number (PAN) using the online scoring algorithm detailed above.

When the profile for a primary account number (PAN) is first created, each topic probability can be set to 1/7.

If the first transaction seen for the primary account number (PAN) is a grocery store purchase, the probability for topic 1 (day to day living) can increase above 1/7, as does the probability for topic 2 (young/student) to a lesser degree. The remaining topic probabilities can decrease so that all probabilities sum to one.

If the second transaction is for online music, the probability for topic 2 (young/student) can increase, while the other probabilities can likely decrease because online music may not be highly probable in the other topics.

This process can continue as the topic probabilities more accurately represent the prototypical spending patterns followed by the users of this primary account number (PAN).

(F) Derived Features and their Use

If we assume the online learning of the topic probability mixture vector uses a value of 50 for the constant B, then the topic mixture can contain a long-term average of the cardholder's behavior given that most cards can be used less than once per day on average.

The computed values of the predictive features, such as predictive code length feature or relative predictive code length features, as noted above, reveal the likelihood of the current transaction based on the prior history on this primary account number (PAN).

These predictive features can be provided as input to a statistical model, along with many other features typically used in payment card fraud detection, to predict whether or not this transaction is fraudulent.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein does not require the particular order shown, or sequential order, to achieve desirable results. Other embodiments may be within the scope of the following claims.

What is claimed is:

1. A non-transitory computer program product storing instructions that, when executed by at least one programmable processor, cause the at least one programmable processor to perform operations comprising:
receiving data characterizing at least one transaction;
calculating, using a topic probability mixture vector, values of one or more predictive features, the topic probability mixture vector being generated by a topic model trained on historical data comprising historical transactions, the topic probability mixture vector being updated when the data characterizing the at least one transaction is received; and
scoring, based on the values of the one or more predictive features, the at least one transaction.

2. The computer program product of claim 1, wherein:
the at least one transaction is between a first set of one or more merchants and a first set of one or more customers; and
the historical transactions are between a second set of one or more merchants and a second set of one or more customers.

3. The computer program product of claim 2, wherein:
the first set of one or more merchants is different from the second set of one or more customers; and
the first set of one or more merchants is different from the second set of one or more customers.

4. The computer program product of claim 1, wherein the topic model is a latent Dirichlet allocation (LDA) model.

5. The computer program product of claim 1, wherein the updating of the topic probability mixture vector comprises:
initializing a first vector characterizing a multiple of the topic probability mixture vector;
applying an optional time delay to the first vector to modify the first vector;
computing, based on the modified first vector, an initial estimate of the topic probability mixture vector;
computing, based on the initial estimate of the topic probability mixture vector, a second vector;
enhancing the second vector by using a temporary vector;
updating, based on the enhanced second vector and an upper bound characterizing a time window for collecting the historical data, the modified first vector; and
computing, based on the updated first vector, a final value of the topic probability mixture vector, the final value of the topic probability mixture vector being the updated topic probability mixture vector.

6. The computer program product of claim 5, wherein the time delay is characterized by: exp(−Δ/T),
wherein: exp is an exponential function, Δ is a time difference between an old transaction and a new transaction, and T is a time constant.

7. The computer program product of claim 5, wherein the initial estimate of the topic probability mixture vector is characterized by:
$${θ}_{k} = \frac{{ζ}_{k}}{{\sum }_{k = 1}^{K} {ζ}_{k}} ,$$
wherein: θₖ is k^{th} value in the topic probability mixture vector θ, ζ is the modified first vector, and ζₖ is k^{th} value in the modified first vector ζ.

8. The computer program product of claim 5, wherein the second vector γ is characterized by: γ_{n,k}=p(tₖ|wₙ,θ),
wherein:
$$p ( {t}_{k} \vert {w}_{n} , θ ) = \frac{p ( {w}_{n} \vert {t}_{k} , θ ) p ( {t}_{k} \vert θ )}{p ( {w}_{n} \vert θ )} = \frac{{φ}_{m , k} {θ}_{k}}{p ( {w}_{n} \vert θ )} ,$$
m is an index of a current word in the topic matrix φ, and θₖ is k^{th} element of the topic probability mixture vector θ,
wherein
$$p ( {w}_{n} \vert θ ) = {\sum }_{k = 1}^{K} {φ}_{m , k} {θ}_{k} .$$

9. The computer program product of claim 5, wherein the temporary vector τ is characterized by:
$${τ}_{k} = {ζ}_{k} + {\sum }_{n = 1}^{N} {γ}_{n , k} ,$$
wherein ζₖ is k^{th} value in the modified first vector ζ, and γ is the second vector.

10. The computer program product of claim 1, wherein the one or more predictive features comprise a predictive code length feature characterized by:
$${L}_{w} = - log \hat{p} ( w \vert θ ) = - log ( {\sum }_{k} {φ}_{m , k} {θ}_{k} )$$
wherein:
L_{w} is a predictive code length of a new word w associated with the received data characterizing the at least one transaction;
\hat{p}(w|θ) is a conditional probability associated with new word w and topic vector θ; and
Φ_{m,k} is a probability of a word m being associated with a topic k.

11. The computer program product of claim 10, wherein:
the predictive code length characterizes a minimum code length required to compress the new word in a sequentially updating lossless compression;
common words have a low value of the predictive code length; and
uncommon words have a high value of the predictive code length.

12. The computer program product of claim 1, wherein the one or more predictive features comprise a relative predictive code length feature characterized by:
\tilde{L}_{w}=−log \hat{p}(w|θ)−log \hat{p}(w)
wherein:
$$- log \hat{p} ( w \vert θ ) = - log ( {\sum }_{k} {φ}_{m , k} {θ}_{k} ) ;$$
L_{w} is a relative predictive code length of a new word w;
\hat{p}(w|θ) is a conditional probability associated with new word w and topic vector θ;
Φ_{m,k} is a probability of a word m being associated with a topic k; and
\hat{p}(w) is a baseline probability of the new word determined regardless of the historical data.

13. The computer program product of claim 1, wherein the one or more predictive features are provided as input to one or more predictive models that generate the score.

14. The computer program product of claim 13, wherein the one or more predictive models comprise at least one of: linear regression models, nonlinear regression models, artificial neural network models, decision trees, support vector machines, and scorecard models.

15. A method comprising:
receiving historical data comprising data associated with transactions between a first set of one or more transacting partners and a first set of one or more transacting entities;
generating, from the historical data, characteristics characterizing words;
obtaining a numerical value of a number of topics desired to be determined;
determining the numerical value number of topics that are associated with the one or more transacting entities;
associating the topics with the words in a topic model; and
generating a topic probability mixture vector by using the topic model, the topic vector being updated in run-time to characterize risk associated with subsequent transactions in the run-time.

16. The method of claim 15, wherein:
the historical data is selected for a variable time period;
the historical data is received at a characteristics generator; and
the characteristics are generated by the characteristics generator.

17. The method of claim 15, wherein:
the words characterize categorical data in the historical data; and
the topics characterize patterns determined from the historical data.

18. The method of claim 15, wherein the topic model characterizes a topic-word matrix that provides a measure of association between words and topics.

19. The method of claim 15, wherein:
each value in the topic-word matrix characterizes a probability of association of a specific word with a corresponding topic; and
the topic probability mixture vector comprises probabilities, each probability characterizing a likelihood of association of a particular word with a respective topic.

20. The method of claim 15, further comprising:
receiving a new data characterizing one or more transactions between a second set of one or more new transacting partners and a second set of one or more new transacting entities;
updating the topic probability mixture vector when the new data is received;
calculating, based on at least one of the topic probability mixture vector prior to the update and the updated topic probability mixture vector, values of one or more predictive features;
scoring, based on the calculated values of the one or more predicted features, a transaction in the new data to generate a score; and
initiating a provision of the score.

21. The method of claim 20, wherein:
the first set of one or more transacting partners is different from the second set of one or more new transacting partners; and
the first set of one or more transacting entities is different from the second set of one or more new transacting entities.

22. The method of claim 20, further comprising:
extracting, from the new data, new words to be input to the topic model; and
generating, by the topic model, the updated topic probability mixture vector.

23. The method of claim 20, wherein the updating of the topic vector comprises updating a multiple associated with the topic vector, the multiple being stored and associated with a profiled transacting entity until another new transaction is received while the topic vector is discarded.

24. The method of claim 20, wherein the one or more predictive features comprise a predictive code length feature characterized by:
$${L}_{w} = - log \hat{p} ( w \vert θ ) = - log ( {\sum }_{k} {φ}_{m , k} {θ}_{k} )$$
wherein:
L_{w} is a predictive code length of a new word w;
\hat{p}(w|θ) is a conditional probability associated with new word w and topic vector θ; and
Φm,k is a probability of a word m being associated with a topic k; and
wherein:
the predictive code length characterizes a minimum code length required to compress the new word in a sequentially updating lossless compression;
common words have a low value of the predictive code length; and
unlikely words have a high value of the predictive code length.

25. The method of claim 20, wherein the one or more predictive features comprise a relative predictive code length feature characterized by:
\tilde{L}_{w}=−log \hat{p}(w|θ)−log \hat{p}(w)
wherein:
$$- log \hat{p} ( w \vert θ ) = - log ( {\sum }_{k} {φ}_{m , k} {θ}_{k} ) ;$$
L_{w} is a relative predictive code length of a new word w;
\hat{p}(w|θ) is a conditional probability associated with new word w and topic vector θ;
Φ_{m,k} is a probability of a word m being associated with a topic k; and
\hat{p}(w) is a baseline probability of the new word determined regardless of data associated with a specific transacting entity.

26. The method of claim 20, wherein the one or more predictive features comprise a distribution distance feature comprising at least one of: Kullback-Leibler divergence, Hellinger distance, Euclidean distance, mean absolute deviation, maximum absolute deviation, and Jensen-Shannon divergence.

27. The method of claim 20, wherein the one or more predictive features comprise topic-distribution components and associated functions.

28. The method of claim 20, wherein the one or more predictive features are provided as input to two or more predictive models that generate the score and that are implemented in series, the one or more predictive models comprise two or more of: logistic regression models, artificial neural network models, decision trees, support vector machines, and scorecard models.

29. The method of claim 27, wherein the initiation of the score occurs over a network.

30. The method of claim 29, wherein the network is internet.

31. The method of claim 15, wherein the first number of words characterize one or more payment transaction characteristics comprising merchant category codes, merchant postal codes, discrete transaction amount, and discrete transaction time.

32. The method of claim 15, wherein the first number of words characterize characteristics unique to merchants, the unique characteristics comprising postal codes of clients of the merchants, discrete credit lines of credit cards of the clients, and a bank identity number portion of a primary account number.

33. The method of claim 15, wherein the first number of words characterize transaction types, a point of sale (POS) entry mode, foreignness of transactions, and localness of transactions.

34. The method of claim 15, wherein the first number of words characterize accessed internet browsers, sequences of one or more products clicked, and time spent in viewing each product.

35. The method of claim 15, wherein the first number of words characterize transaction times, transaction amounts, client postal codes, client credit lines, client cash advance limits, and bank identification numbers of primary account numbers.

36. The method of claim 15, wherein the first number of words characterize types of browsers, version identifiers, language settings, internet protocols, subnet addresses, discrete online session lengths, and sequence of button clicks.

37. The method of claim 15, wherein the first number of words characterize discrete revolving credit balances, relative revolving balance limits, discrete payment ratio that is ratio of payment to most recent due amount, discrete payment delay that is a number of days from billing to payment, a number of recent consecutive delinquent cycles, a total number of delinquent cycles, and finance charges.

38. The method of claim 15, wherein the first number of words characterize specific item codes, item categories, geographical data, a pattern of time of access, sequences of views of web pages, sequences of views of sections in web pages, and sequences of views of items in web pages.

39. A method comprising:
receiving data characterizing at least one transaction;
calculating, using a topic probability mixture vector that is updated when the data is received and that is generated by a latent Dirichlet allocation (LDA) model, values of one or more predictive features; and
scoring, based on the values of the one or more predictive features, the at least one transaction.

40. The method of claim 39, wherein the latent dirichlet allocation (LDA) model is trained on historical data comprising historical transactions.

41. The method of claim 40, wherein the topic probability mixture vector comprises values, a count of the values being equal to a count of topics associated with the historical data, each value characterizing a probability of association of a word from a corresponding transaction with a corresponding topic.

42. The method of claim 40, wherein the updating of the topic probability mixture vector comprises:
initializing a first vector characterizing a multiple of the topic probability mixture vector;
applying a time delay to the first vector to modify the first vector, the modified first vector being obtained by multiplying the first vector by exp(−Δ/T), exp being an exponential function, Δ being a time difference between an older transaction and a newer transaction, T being a time constant;
determining, from the received data, new words characterizing one or more new transactions;
computing an initial estimate of the topic probability mixture vector as
$${θ}_{k} = \frac{{ζ}_{k}}{{\sum }_{k = 1}^{K} {ζ}_{k}} ,$$
θₖ being k^{th} value in the topic probability mixture vector θ, ζ being the modified first vector, and ζₖ being k^{th} value in the modified vector ζ;
computing a second vector γ as γ_{n,k}=p(tₖ|wₙ,θ), wherein
$$p ( {t}_{k} \vert {w}_{n} , θ ) = \frac{p ( {w}_{n} \vert {t}_{k} , θ ) p ( {t}_{k} \vert θ )}{p ( {w}_{n} \vert θ )} = \frac{{φ}_{m , k} {θ}_{k}}{p ( {w}_{n} \vert θ )} ,$$
m being an index of a current word in the topic matrix φ, θₖ being k^{th} element of the topic probability mixture vector θ, and denominator being computed as
$$p ( {w}_{n} \vert θ ) = {\sum }_{k = 1}^{K} {φ}_{m , k} {θ}_{k} ;$$
computing a temporary vector τ as:
$${τ}_{k} = {ζ}_{k} + {\sum }_{n = 1}^{N} {γ}_{n , k} ;$$
updating, using the temporary vector τ, the topic probability mixture vector as
$${θ}_{k} = \frac{{τ}_{k}}{{\sum }_{k = 1}^{K} {τ}_{k}} ;$$
modifying the second vector γ as γ_{n,k}=p(tₖ|wₙ,θ) to enhance the second vector;
updating the modified first vector by:
$${ζ}_{k} {ζ}_{k} + {\sum }_{n = 1}^{N} {γ}_{n , k} ,$$
wherein ζₖ on right side is a prior value of ζₖ, ζₖ on left side is an updated new value of ζₖ;
re-updating the modified first vector by:
$${ζ}_{k} \frac{B \times {ζ}_{k}}{s} ,$$
wherein
$$s = {\sum }_{k = 1}^{K} {ζ}_{k} ,$$
B is an upper bound characterizing a time window for collecting the historical data; and
computing a final value of the topic probability mixture vector as
$${θ}_{k} = \frac{{ζ}_{k}}{{\sum }_{k = 1}^{K} {ζ}_{k}} ,$$
ζₖ being the further re-updated value of the modified first vector, the final value of the topic probability mixture vector being the updated topic probability mixture vector.
